(19) United States
(12) Patent Application Publication
(10) Pub. No.: US 2024/0210788 A1
(43) Pub. Date: Jun. 27, 2024

(54) STOPPER AND CAMERA MODULE INCLUDING STOPPER

(71) Applicant: SAMSUNG ELECTRO-MECHANICS CO., LTD., Suwon-si (KR)

(72) Inventors: Young Hwan KWON, Suwon-si (KR); Su Kyeong KIM, Suwon-si (KR); Soo Cheol LIM, Suwon-si (KR); Young Bok YOON, Suwon-si (KR)

(73) Assignee: SAMSUNG ELECTRO-MECHANICS CO., LTD., Suwon-si (KR)

(21) Appl. No.: 18/347,686

(22) Filed: Jul. 6, 2023

(30) Foreign Application Priority Data
Dec. 26, 2022 (KR) 10-2022-0184980

(51) Int. Cl. G03B 5/04

(52) U.S. Cl. CPC G03B 5/04; G03B 2205/0015

(57) ABSTRACT

A camera module includes a carrier provided in a housing; a guide member disposed in the carrier, and configured to compensate for shaking in a perpendicular direction to an optical axis direction; a stopper configured to cover an upper portion of the carrier to accommodate the guide member; and a damper member, disposed in the stopper, comprising either one or both of an eleventh damper member opposing the guide member in a first direction perpendicular to the optical axis direction, and a twenty first damper member opposing the guide member in a second direction perpendicular to the optical axis direction and the first direction. The damper member directly opposes the guide member.

### CROSS-REFERENCE TO RELATED APPLICATION(S)

This application claims benefit under 35 USC § 119(a) of Korean Patent Application No. 10-2022-0184980 filed on Dec. 26, 2022, in the Korean Intellectual Property Office, the entire disclosure of which is incorporated herein by reference for all purposes.

### BACKGROUND

### 1. Field

The present disclosure relates to a stopper and a camera module, including the stopper.

### 2. Description of Background

Camera modules may be used in mobile communication terminals such as smartphones, tablet PCs, and laptops.

A focus adjustment function and a shake compensation function may be used to generate a high-resolution image in such a camera module.

In mobile communication terminals and camera modules with reduced sizes, the structure for moving the lens in various directions to implement the focus adjustment function and the shake compensation function may allow internal components to move.

In addition, when a ball bearing is used to guide the movement of the lens, the ball bearing is generally provided to allow other members to move in a rolling or sliding motion such that adjacent members may be freely separated from each other.

When such a structure is used to reduce the size of the camera module, the risk of damage to the internal components of the camera module due to external impact may increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a carrier provided in a housing; a guide member disposed in the carrier, and configured to compensate for shaking in a perpendicular direction to an optical axis direction; a stopper configured to cover an upper portion of the carrier to accommodate the guide member; and a damper member, disposed in the stopper, comprising either one or both of an eleventh damper member opposing the guide member in a first direction perpendicular to the optical axis direction, and a twenty first damper member opposing the guide member in a second direction perpendicular to the optical axis direction and the first direction. The damper member directly opposes the guide member.

The damper member may further include either one or both of a twelfth damper member opposing the housing in the first direction, and a twenty-second damper member opposing the housing in the optical axis direction and the second direction.

The stopper may include a body having a shape of a frame, and a plurality of hooks extending from the body in the optical axis direction. The damper member may be disposed on each of the hooks.

The body may have a rectangular shape.

The damper member may be configured as a single member.

The stopper may include an auxiliary member extending from a frame in the optical axis direction, and a plurality of hooks extending from a body in the optical axis direction. The damper member may be configured to fix to one of the hooks and the auxiliary member.

The stopper may include an auxiliary member extending from the frame in the optical axis direction, and the damper member may be configured to fix to one of the hooks and the The stopper may include an auxiliary member extending from a frame in the optical axis direction, and a plurality of hooks extending from a body in the optical axis direction. Each of the hooks may have a through-hole and be configured to fix to the carrier, and the damper member may protrude from opposing sides of the through-hole.

Each of the hooks may have a through-hole and be configured to fix to the carrier. The damper member may protrude from opposing sides of the through-hole.

The damper member may have a fitting groove configured to fit one of the hooks.

The damper member may have a first fitting groove or a second fitting groove configured to fit one of the hooks or the auxiliary member.

The guide member may include a frame and a lens holder, disposed in the carrier in the optical axis direction, moving together with the carrier in the optical axis direction, and movable in the first direction and the second direction, respectively.

The guide member may be configured as a single member, and to be driven in both the first direction and the second direction.

The stopper may include, separately from the damper member, a damping member including either one or both of a first damping member opposing a case of the camera module in the optical axis direction, and a second damping member opposing the guide member in the optical axis direction.

In another general aspect, a stopper includes a body having a rectangular frame; a hook configured to extend from the rectangular frame in a downward direction toward one surface of the frame; and a damper member, disposed on the hook, comprising either one or both of an eleventh directional damper member opposing inwardly in the downward direction and in a first direction perpendicular to the downward direction, or a twenty first directional damper member opposing inwardly in the downward direction and in a second direction perpendicular to the downward direction and the first direction.

The damper member may further include either one or both of an eleventh directional damper member opposing outwardly in the first direction perpendicular to the downward direction, and a twenty first directional damper member opposing outwardly in the second direction perpendicular to the downward direction and the first direction.

The hook may be disposed at a corner portion of the body having a rectangular shape.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of a camera module according to an example embodiment of the present disclosure.

FIG. 3 is an upper perspective view and a partially enlarged view of a stopper of a camera module, according to an example embodiment of the present disclosure.

FIG. 4 is a lower perspective view and a partially enlarged view of a stopper of a camera module, according to an example embodiment of the present disclosure.

FIG. 5 is an exploded perspective view of a lower portion of a stopper and a damper member of a camera module, according to an example embodiment of the present disclosure.

FIG. 6 is an exploded perspective view of a lower portion of a stopper and a damper member of a camera module, according to another embodiment of the present disclosure.

FIGS. 7 and 8 are partial plan cross-sectional views of portion A-A′ of FIG. 1, and respectively illustrate different corner portions.

FIG. 9 is a partial cross-sectional view of portion B-B′ of FIG. 1.

FIG. 10 is an exploded perspective view of a guide member according to an example embodiment of the present disclosure.

FIG. 11 is an exploded perspective view of a guide member according to another example embodiment of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences within and/or of operations described herein are merely examples, and are not limited to those set forth herein, but may be changed as will be apparent after an understanding of this disclosure, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of this disclosure may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The present disclosure relates to a stopper and a camera module, including the stopper, and applies to portable electronic devices such as mobile communication terminals, smartphones, and tablet PCs.

An aspect of the present disclosure describes a camera module having a shock absorbing structure against external impacts while having a reduced size.

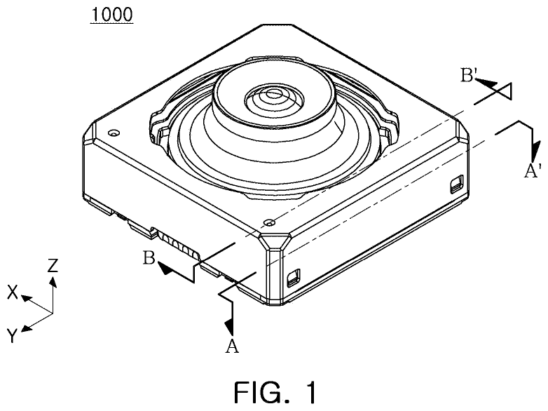

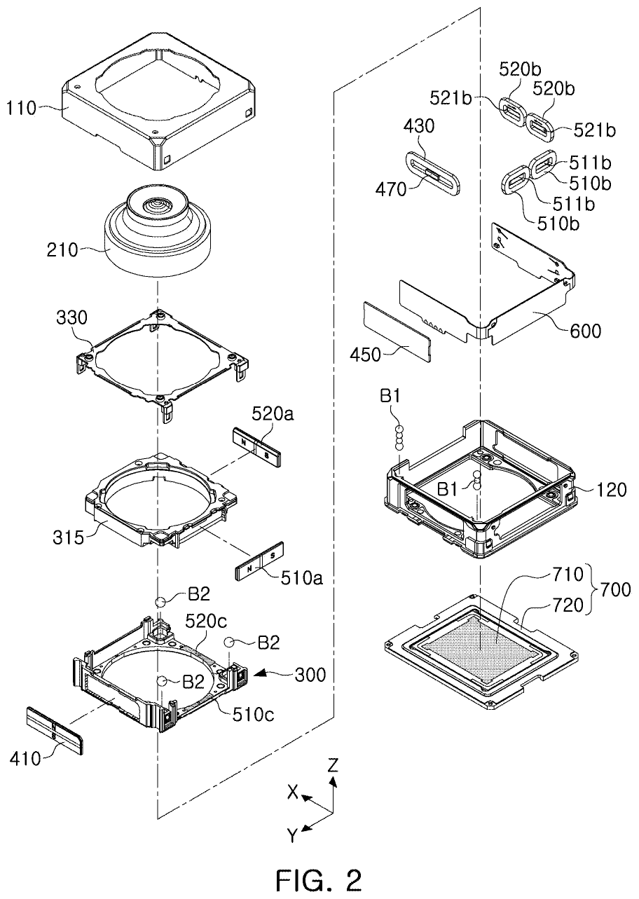

FIG. 1 is a perspective view of a camera module according to an example embodiment of the present disclosure. FIG. 2 is a schematic exploded perspective view of a camera module according to an example embodiment of the present disclosure.

Referring to FIGS. 1 and 2, a camera module 1000, according to an example embodiment of the present disclosure, may include a lens barrel 210, a lens driving apparatus for moving the lens barrel 210, an image sensor module 700 converting light incident through the lens barrel 210 into an electrical signal, and a housing 120 and a case 110 accommodating the lens barrel 210 and the lens driving apparatus.

The lens barrel 210 may have a hollow cylindrical shape such that a plurality of lenses for capturing an image of a subject is accommodated therein, and the plurality of lenses may be mounted in the lens barrel 210 along an optical axis.

The desired number of the plurality of lenses may vary depending on the design of the lens barrel 210, and the respective lens may have optical properties such as the same refractive index, different refractive indices, or the like.

The lens driving apparatus may be an apparatus moving the lens barrel 210.

For example, the lens driving apparatus may perform focus adjustment by moving the lens barrel 210 in an optical axis (Z-axis) direction and may compensate for the shaking of the camera module 1000 during image capturing by moving the lens barrel 210 in a direction perpendicular to an optical axis (Z-axis).

The lens driving apparatus may include a focus adjustment unit 400 performing focus adjustment and a shake compensation unit 500 compensating for the shaking of the camera.

The image sensor module 700 may be an apparatus converting light incident through the lens barrel 210 into an electrical signal.

For example, the image sensor module 700 may include an image sensor 710 and a printed circuit board 720 connected to the image sensor 710, and may further include an infrared filter.

The infrared filter may serve to block light in an infrared region in the light incident through the lens barrel 210.

The image sensor 710 may convert the light incident through the lens barrel 210 into

an electrical signal. For example, the image sensor 710 may be a charge-coupled device (CCD) or a complementary metal-oxide semiconductor (CMOS).

The electrical signal converted by the image sensor 710 may be output as an image through a display unit of a portable electronic device.

The image sensor 710 may be fixed to the printed circuit board 720, and may be electrically connected to the printed circuit board 720 by wire bonding.

The lens barrel 210 and the lens driving apparatus may be accommodated in the housing 120.

For example, the housing 120 may have open upper and lower portions, and the lens barrel 210 and the lens driving apparatus may be accommodated in an internal space of the housing 120.

The image sensor module 700 may be disposed below the housing 120.

In addition, a substrate 600, providing a driving signal to the focus adjustment unit 400 and the shake compensation unit 500, may be disposed on a side surface of the housing 120. The substrate 600 may be provided as a single substrate 600 surrounding the side surface of the housing 120.

As will be described below, the side surface of the housing 120 may have an opening, such that a driving coil 430 of the focus adjustment unit 400, and a first driving coil 510b, a second driving coil 520b, and second position detection units 511b and 521b of the shake compensation unit 500 may be inserted thereinto.

The case 110 may be coupled to the housing 120, and may serve to protect the internal components of the camera module 100.

In addition, the case 110 may serve to shield electromagnetic waves.

For example, the case 110 may shield electromagnetic waves such that the electromagnetic waves generated in the camera module do not affect other electronic components in the portable electronic device.

In addition, various electronic components in addition to the camera module may be mounted in the portable electronic device, such that the case 110 may shield electromagnetic waves such that electromagnetic waves generated in the electronic components may not affect the camera module.

The case 110 may be formed of a metal material to be grounded to a ground pad provided in the printed circuit board 720, thereby shielding electromagnetic waves.

Referring to FIG. 2, the focus adjustment unit 400 of the lens driving apparatus of the camera module 1000 will be described according to an example embodiment of the present disclosure.

The lens driving apparatus may move the lens barrel 210 to focus on a subject.

For example, in the present disclosure, the focus adjustment unit 400, moving the lens barrel 210 in the optical axis (Z-axis) direction, may be included.

The focus adjustment unit 400 may include a carrier 300 accommodating the lens barrel 210, a magnet 410, and a driving coil 430. The magnet 410 and the driving coil 430 may generate the driving force to move the lens barrel 210 and the carrier 300 in the optical axis (Z-axis) direction.

The magnet 410 may be mounted on the carrier 300. For example, the magnet 410 may be mounted on one surface of the carrier 300.

The driving coil 430 may be a copper foil pattern in which winding coils are attached to the substrate 600 or are stacked and embedded in the substrate 600. The substrate 600 may be mounted on a side surface of the housing 120 such that the magnet 410 and the driving coil 430 oppose each other in a direction perpendicular to the optical axis (Z-axis).

The magnet 410 may be a moving member mounted on the carrier 300 to move together with the carrier 300 in the optical axis (Z-axis) direction, and the driving coil 430 may be a fixed member fixed to the housing 120.

When power is applied to the driving coil 430, the carrier 300 may be moved in the optical axis (Z-axis) direction by electromagnetic interaction between the magnet 410 and the driving coil 430.

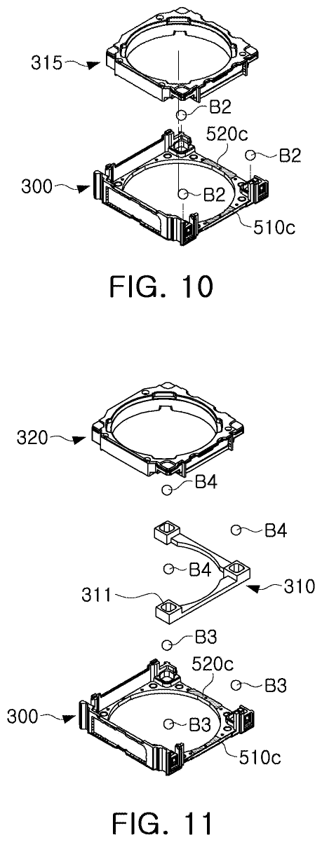

Referring to FIGS. 2 and 10, the guide member 315 may be accommodated in the carrier 300 to implement shake compensation, and the lens barrel 210 may be mounted in the guide member 315, such that the guide member 315 and the lens barrel 210 may also be moved in the optical axis (Z-axis) direction by the movement of the carrier 300. In this case, the guide member 315 may move in both X-axis and Y-axis directions, perpendicular to the optical axis direction.

Referring to FIGS. 2 and 11 as another example embodiment, the guide member 315 may be provided as a separation-type guide member. The guide member 315, including a frame 310 and a lens holder 320, may be accommodated in the carrier 300, and the lens barrel 210 may be mounted in the lens holder 320. In this case, the frame 310, the lens holder 320, and the lens barrel 210 may be moved in the optical axis (Z-axis) direction by the movement of the carrier 300.

When the carrier 300 is moved, a rolling members B1 may be disposed between the carrier 300 and the housing 120 to reduce friction between the carrier 300 and the housing 120. The rolling member B1 may be in the form of a ball.

The rolling member B1 may be disposed on opposite sides of the magnet 410.

The first yoke 450 may be disposed to oppose the magnet 410 in a direction perpendicular to the optical axis (Z-axis). For example, the first yoke 450 may be mounted on an outer side surface of the substrate 600 (a surface opposite to the surface on which the driving coil 430 is provided). Accordingly, the first yoke 450 may be disposed to oppose the magnet 410 with the driving coil 430 interposed therebetween.

Attractive force may act between the first yoke 450 and the magnet 410 in a direction perpendicular to the optical axis (Z-axis).

Accordingly, the rolling member B1 may maintain a state of contact with the carrier 300 and the housing 120 due to the attractive force between the first yoke 450 and the magnet 410.

In addition, the first yoke 450 may also focus the magnetic force of the magnet 410, thereby preventing magnetic flux leakage from occurring.

For example, the first yoke 450 and the magnet 410 may form a magnetic circuit.

In the present disclosure, a closed-loop control method may be used to detect a position of the lens barrel 210 and provide feedback related thereto.

Accordingly, a first position detection unit 470 may be provided for closed-loop control. The first position detection unit 470 may use various sensing methods, such as an inductance sensing method using at least one coil, a hall sensor sensing method, etc.

Subsequently, the shake compensation unit 500 of the lens driving apparatus of the camera module 1000, according to an example embodiment of the present disclosure, will be described with reference to FIGS. 2, 10, and 11.

The shake compensation unit 500 may compensate for image blurring or distortion due to an external vibration factor, such as a user's hand shaking when the image is captured, or the video is recorded.

For example, when the camera module 1000 is shaken during image capturing due to the shaking of the user's hand or the like, the shake compensation unit 500 may impart relative displacement corresponding to the shaking of the camera to the lens barrel 210, thereby compensating for the shaking of the camera.

For example, the shake compensation unit 500 may compensate for the shaking of the camera module 1000 by moving the lens barrel 210 in a direction perpendicular to the optical axis (Z-axis).

The shake compensation unit 500 may include a guide member 315 guiding the movement of the lens barrel 210, and a plurality of magnets and a plurality of coils generating driving force to move the guide member 315 in a direction perpendicular to the optical axis (Z-axis).

The plurality of magnets may include a first magnet 510a and a second magnet 520a, and the plurality of coils may include a first driving coil 510b and a second driving coil 520b.

Referring to FIGS. 2 and 10, the guide member 315 may be inserted into the carrier 300 and may serve to guide the movement of the lens barrel 210 mounted in the guide member 315. The guide member 315 has a space into which the lens barrel 210 is insertable. The lens barrel 210 may be inserted into and fixed to the lens holder 320. The guide member 315 may be provided as a single member and, thus, may be provided to move in a first direction perpendicular to the optical axis direction, and a second direction perpendicular to both the optical axis direction and the first direction.

In addition, referring to FIG. 11, the guide member 315 may include the frame 310 and the lens holder 320. In an example, the frame 310 and the lens holder 320 may be sequentially inserted into the carrier 300 in the optical axis (Z-axis) direction, and may serve to guide the movement of the lens barrel 210. In this case, the frame 310 may serve to guide the movement in the first direction perpendicular to the optical axis direction, and the lens holder 320 may serve to guide the movement in the second direction perpendicular to both the optical axis direction and the first direction.

The frame 310 and the lens holder 320 have a space into which the lens barrel 210 is insertable. Therefore, the lens barrel 210 may be inserted into and fixed to the lens holder 320.

The guide member 315 disposed on an upper portion of the carrier 300 in the optical axis direction with the ball member B2 interposed therebetween may move in the first and second directions. To this end, the guide member 315 may include a first magnet 510a and a second magnet 520a disposed on mutually perpendicular surfaces thereof to be parallel to the optical axis direction.

The guide member 315 may be moved in a direction perpendicular to the optical axis (Z-axis), with respect to the carrier 300, by a driving force generated by a plurality of magnets and a plurality of coils.

The first magnet 510a and the first driving coil 510b may generate driving force in a first axis (X-axis) direction perpendicular to the optical axis (Z-axis), and the second magnet 520a and the second driving coil 520b) may generate driving force in a second axis (Y-axis) direction perpendicular to the first axis (X-axis). That is, the plurality of magnets and the plurality of coils may generate driving forces in directions opposing each other.

Here, the second axis (X-axis) may refer to an axis perpendicular to both the optical axis (Z-axis) and the first axis (Y-axis).

The plurality of magnets may be disposed to be orthogonal to each other on a plane perpendicular to the optical axis (Z-axis), and the plurality of coils may also be disposed to be orthogonal to each other on the plane perpendicular to the optical axis (Z-axis).

In another example embodiment described with reference to FIG. 11, the guide member 315 may include the frame 310 and the lens holder 320.

The frame 310 and the lens holder 320 may be moved in a direction perpendicular to the optical axis (Z-axis), with respect to the carrier 300, by a driving force generated by a plurality of magnets and a plurality of coils.

The first magnet 510a and the first driving coil 510b may generate driving force in a first axis (X-axis) direction perpendicular to the optical axis (Z-axis), and the second magnet 520a and the second driving coil 520b) may generate driving force in a second axis (Y-axis) direction perpendicular to the first axis (X-axis). That is, the plurality of magnets and the plurality of coils may generate driving forces in directions opposing each other.

Here, the second axis (X-axis) may refer to an axis perpendicular to both the optical axis (Z-axis) and the first axis (Y-axis).

The plurality of magnets may be disposed to be orthogonal to each other on a plane perpendicular to the optical axis (Z-axis), and the plurality of coils may also be disposed to be orthogonal to each other on the plane perpendicular to the optical axis (Z-axis).

The first magnet 510a, and the second magnet 520a may be mounted on the lens holder 320. For example, the first magnet 510a and the second magnet 520a may be respectively mounted on the side surfaces of the lens holder 320. The side surfaces of the lens holder 320 may include a first surface and a second surface perpendicular to each other, and the first magnet 510a and the second magnet 520a may be disposed on the first surface and the second surface of the lens holder 320.

The first driving coil 510b and the second driving coil 520b may be winding coils mounted on the substrate 600 or may be stacked and embedded in copper foil patterns. The substrate 600 may be mounted on a side surface of the housing 120 such that the first magnet 510a and the first driving coil 510b oppose each other in a direction perpendicular to the optical axis (Z-axis), and the second magnet 520a and the second driving coil 520b oppose each other in a direction perpendicular to the optical axis (Z-axis).

The first magnet 510a and the second magnet 520a may be moving members moving together with the guide member 315 in a direction perpendicular to the optical axis (Z-axis), and the first driving coil 510b and the second driving coil 520b may be fixed members fixed to the housing 120.

In the present disclosure, a plurality of ball members may be provided, supporting the guide member 315 or the frame 310 and the lens holder 320 of the shake compensation unit 500. The plurality of ball members may guide the movement of the frame 310, the lens holder 320, and the lens barrel 210 in a shake compensation process. In addition, the plurality of ball members may also maintain intervals between the carrier 300, the frame 310, and the lens holder 320.

Referring to FIG. 10, the plurality of ball members may include a second ball member B2. The second ball member B2 may guide the movement of the guide member 315 in the first axis (X-axis) direction and the second axis (Y-axis) direction.

Referring to FIG. 11, the plurality of ball members may include a third ball member B3 and a fourth ball member B4.

The third ball member B3 may guide the movement of the frame 310, the lens holder 320, and the lens barrel 210 in the first axis (X-axis) direction, and the fourth ball member B4 guides the movement of the lens holder 320 and the lens barrel 210 in the second axis (Y-axis) direction.

For example, the third ball member B3 may be movable in a rolling motion in the first axis (X-axis) direction when driving force is generated in the first axis (X-axis) direction. Accordingly, the third ball member B3 may guide the movement of the frame 310, the lens holder 320, and the lens barrel 210 in the first axis (X-axis) direction.

In addition, the fourth ball member B4 may be movable in a rolling motion in the second axis (Y-axis) direction when driving force is generated in the second axis (Y-axis) direction. Accordingly, the fourth ball member B4 may guide the movement of the lens holder 320 and the lens barrel 210 in the second axis (Y-axis) direction.

The third ball member B3 may include a plurality of ball members disposed between the carrier 300 and the frame 310, and the fourth ball member B4 may include a plurality of ball members disposed between the frame 310 and the lens holder 320.

When driving force is generated in the first axis (X-axis) direction, the guide member 315—or the frame 310, the lens holder 320- and the lens barrel 210 may move together in the first axis (X-axis) direction.

In addition, when driving force is generated in the second axis (Y-axis) direction, either the guide member 315 or the lens holder 320, and the lens barrel 210 may move in the second axis (Y-axis) direction.

In the present disclosure, a plurality of yokes 510c and 520c may be provided to maintain a state of contact between the shake compensation unit 500 and the second to fourth members B2, B3, and B4.

The plurality of yokes 510c and 520c may be fixed to the carrier 300, and may be disposed to oppose the first magnet 510a and the second magnet 520a in the optical axis (Z-axis) direction.

Accordingly, attractive force may be generated between the plurality of yokes 510c and 520c and the first and second magnets 510a and 520a in the optical axis (Z-axis) direction.

The shake compensation unit 500 may be pressed in a direction toward the plurality of yokes 510c and 520c by the attractive force generated between the plurality of yokes 510c and 520c and the first and second magnets 510a and 520a, such that the frame 310 and the lens holder 320 of the shake compensation unit 500 may maintain a state of contact with the second to fourth ball members B2, B3, and B4.

The plurality of yokes 510c and 520c may be formed of a material capable of generating attractive force between the first magnet 510a and the second magnet 520a. For example, the plurality of yokes 510c and 520c may be formed from a magnetic material.

In the present disclosure, a closed-loop control method may be used to detect a position of the lens barrel 210 and provide feedback related thereto in a shake compensation process.

Thus, a second position detection unit for closed-loop control may be provided. The second position detection unit may be configured to detect a position of the lens barrel 210 in the first axis (X-axis) direction and the second axis (Y-axis) direction.

The second position detection unit may use an inductance sensing method using either one or both of a coil or a hall sensor.

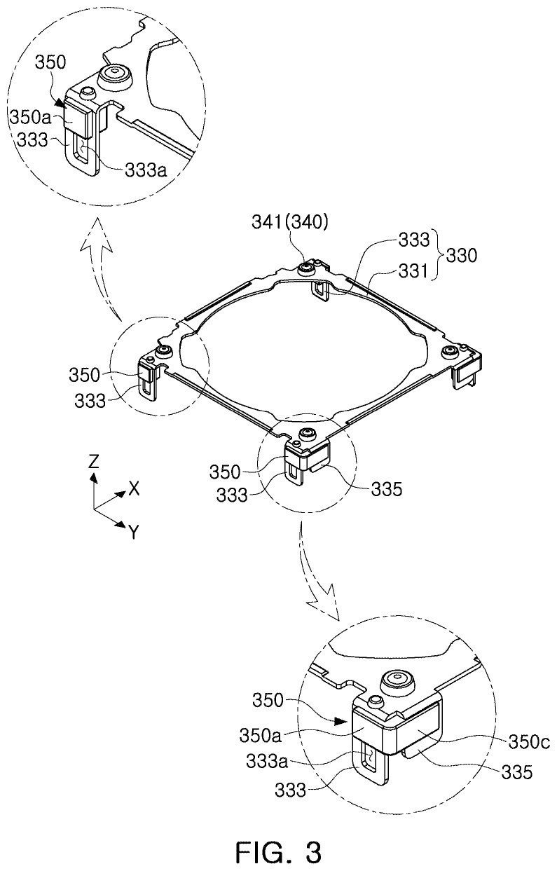

Referring to FIGS. 3 to 9, the camera module, according to an example embodiment of the present disclosure, may include a stopper 330 to prevent the guide member 315—the frame 310 and the lens holder 320- to be deviated to the outside of the carrier 300 by external impacts or the like, and to absorb impacts.

The stopper 330 may be coupled to the carrier 300 to cover at least a portion of an upper surface of the lens holder 320. In other words, the stopper 330 may be coupled to an upper portion of the carrier 300 into which the guide member 315 is inserted.

The guide member 315 may be disposed in the carrier 300, and may serve to compensate for shaking in a direction perpendicular to the optical axis direction. The guide member 315 may be provided while being supported by a ball member and, thus, may move in an unintended direction when externally impacted. Accordingly, the stopper 33, covering the upper portion of the carrier 300, may be provided such that the guide member 315 is accommodated therein.

In addition, a damper member may be provided in the stopper 330 to absorb impacts upon contact with an adjacent member. The damper member may include a vertical damper member 340 absorbing impacts between adjacent members in the optical axis direction, and a horizontal damper member 350 absorbing impacts between adjacent members in a direction perpendicular to the optical axis. Either one or both of the vertical damper member 340 and the horizontal damper member 350 may be provided together.

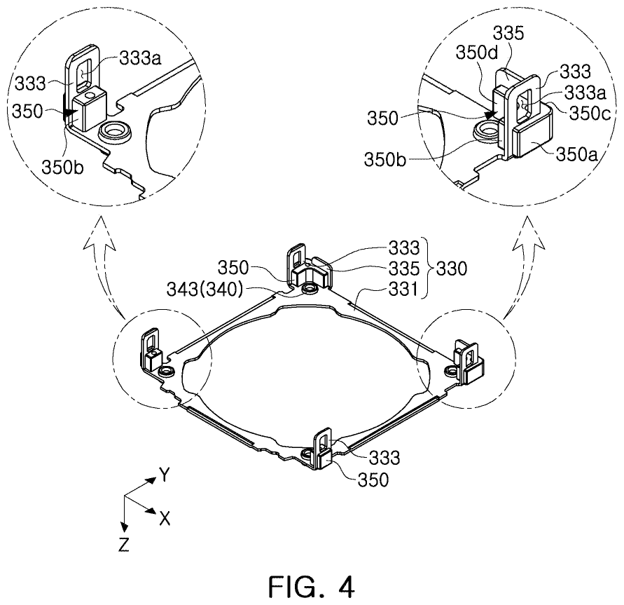

Referring to FIGS. 3 and 4, the stopper 330 may include a body 331 having a frame shape, and the body 331 may include a plurality of hooks 333 extending in the optical axis direction. The hook 333 may be fitted into and fixed to the carrier 300. In the present example embodiment, the hook 333 may include the horizontal damper member 350 to streamline the manufacturing process.

The vertical damper member 340 may be provided to pass through the body 331 and thereby be exposed to the upper and lower surfaces of the body 331 in the optical axis direction. The body 331 may have a plate shape with a surface perpendicular to the optical axis direction and a surface parallel to the optical axis direction. The vertical damper member 340 may be fitted into and fixed to the body 331 or fixed by a bonding structure using an adhesive. Accordingly, the vertical damper member 340 may include a first damping member 341 protruding toward the case 110 and a second damping member 343 protruding toward the guide member 315.

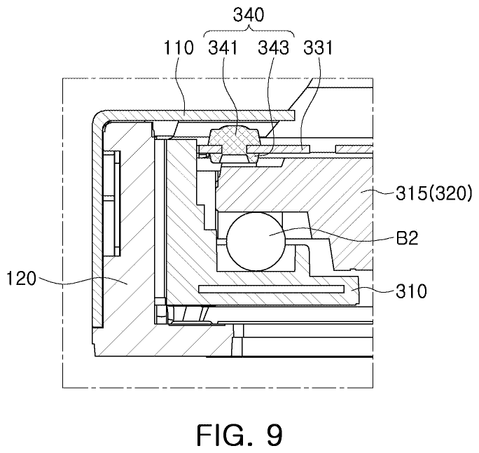

Referring to FIG. 9, even when the guide member 315—or the lens holder 320—moving in the optical axis direction comes into contact with the case 110, impacts may be easily absorbed by the vertical damper member 340. In addition, the vertical damper member 340 may be provided to directly oppose the guide member 315, —or the lens holder 320.

The horizontal damper member 350 may be provided in the hook 333. The hook 333 may extend in the optical axis direction, and may have a plate shape to be fitted into and fixed to a fixing protrusion 301 provided in the carrier 300. Accordingly, the hook 333 may have a through-hole 333a.

A plurality of horizontal damper members 350 may be provided in each hook 333. The plurality of horizontal damper members 350 may be generally used to fix the stopper 330 to the carrier 300. In a non-limiting example, four horizontal damper members 350 may be provided, considering that the body 331 is rectangular.

The horizontal damper member 350 may include any one or any combination of any two or more of an eleventh damper member 350a opposing the housing 120 in a first direction perpendicular to the optical axis direction, a twelfth damper member 350b opposing the guide member 315 in the first direction perpendicular to the optical axis direction, a twenty-first damper member 350c opposing the housing 120 in a second direction perpendicular in the optical axis direction and the first direction, and a twenty-second damper member 350d opposing the guide member 315 in the optical axis direction and the second direction.

In addition, the horizontal damper member 350 may be provided to include at least one damper member, including the twelfth damper member 350b and the twenty-second damper member 350d opposing the guide member 315, among the eleventh damper member 350a, the twelfth damper member 350b, the twenty-first damper member 350c, and the twenty-second damper member 350d. That is, the horizontal damper member 350, according to the present example embodiment, may be provided as the twelfth damper member 350b or the twenty-second damper member 350d opposing the guide member 315, or may further include another damper member. In addition, the horizontal damper member 350 may be provided to directly oppose the guide member 315.

In addition, the horizontal damper member 350 may include any one or any combination of any two or more of the eleventh damper member 350a, the twelfth damper member 350b, the twenty-first damper member 350c, and the twenty-second damper member 350d. The eleventh damper member 350a, the twelfth damper member 350b, the twenty-first damper member 350c, and the twenty-second damper member 350d may be provided integrally, that is, as a single member.

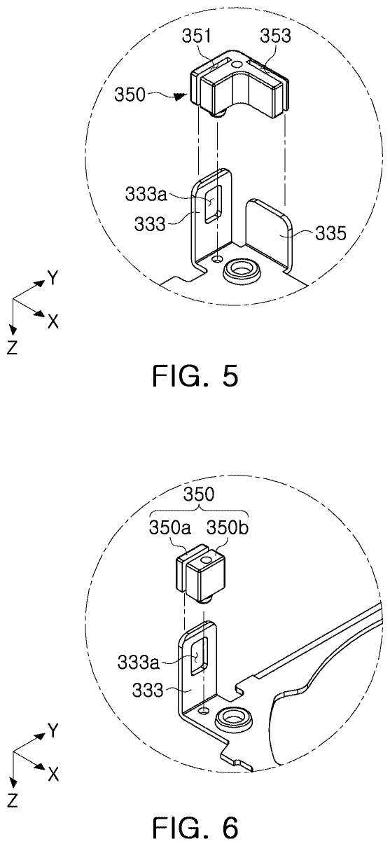

Referring to FIG. 5, the horizontal damper member 350 may further include an auxiliary member 335 extending from the body 331 of the frame 330 in the optical axis direction. The horizontal damper member 350 may be fixed to the hook 333 and the auxiliary member 335 together. The hook 333 and the auxiliary member 335 may respectively extend from perimeters of the body 331 having a rectangular shape perpendicularly intersecting each other, and accordingly, extension lines of the hook 333 and the auxiliary member 335 may perpendicularly intersect each other. Accordingly, the damper member 350 fixed to the hook 333 and the auxiliary member 335 may form a damper structure in various directions.

The damper member 350 may have a first fitting groove 351 into which the hook 333 is fitted. In addition, the damper member 350 may have a second fitting groove 353 into which the auxiliary member 335 is inserted. The damper member 350 may also be fitted into the fitting grooves 351 and 353 in a press-fitting structure, or may additionally have a bonding structure using an adhesive.

Accordingly, the damper member 350, having a structure in which the damper member 350 is simultaneously fitted into the hook 333 and the auxiliary member 335, may have a “¬” shape, and each member may have fitting grooves 351 and 353.

In addition, referring to FIG. 6, the hook 333 of the horizontal damper member 350 may have a through-hole 333a fixed to the carrier 300, and the damper member 350 may be fitted into the through-hole 333a to protrude from opposite sides of the through-hole 333a. In addition, although not illustrated, even in the case of having such a structure, an additional auxiliary member (not illustrated) may be provided as illustrated in FIG. 5, and the auxiliary member may have a through-hole, such that a horizontal damper member (not illustrated) may be additionally provided.

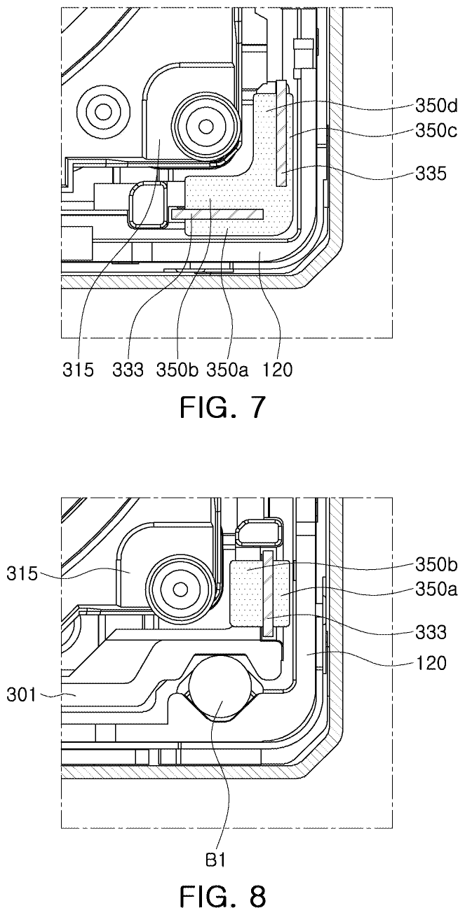

Referring to FIGS. 7 and 8, even when the guide member 315 or the lens holder 320 moving in first and second directions, perpendicular to the optical axis direction, by the horizontal damper member 350 comes into contact with the carrier 300, the guide member 315, or the lens holder 320, a structure in which impact is absorbed may be easily identified.

Referring to FIGS. 3 and 4, the stopper 330, according to an example embodiment of the present disclosure, may include the body 331 having a rectangular frame, the hook 333 provided to extend from the body 331 downwardly in the optical axis direction of the body 331, and the damper member 350 provided in the hook 333.

In addition, the damper member 350 may include an eleventh directional damper member 350a opposing outwardly in a first direction perpendicular to the optical axis direction, and a twenty-first directional damper member 350c opposing outwardly in a second direction perpendicular to the optical axis direction and the first direction, a twelfth directional damper member 350b opposing inwardly in the first direction, and a twenty-second directional damper member 350d opposing inwardly in the second direction.

In addition, the horizontal damper member 350 may be provided to include at least one damper member, including the twelfth damper member 350b or the twenty-second damper member 350d opposing inwardly, among the eleventh damper member 350a, the twelfth damper member 350b, the twenty-first damper member 350c, and the twenty-second damper member 350d.

That is, the horizontal damper member 350, according to the present example embodiment, may be provided as the twelfth damper member 350b or the twenty-second damper member 350d opposing the guide member 315, or may additionally include another damper member.

In addition, the horizontal damper member 350 may include at least one of the eleventh damper member 350a, the twelfth damper member 350b, the twenty-first damper member 350c, and the twenty-second damper member 350d, and the eleventh damper member 350a, the twelfth damper member 350b, the twenty-first damper member 350c, and the twenty-second damper member 350d may be provided integrally, that is, as a single member.

In addition, as described above, the stopper 330, according to the present example embodiment, may further include the auxiliary member 335 extending from the body 331 with a rectangular frame downwardly in the optical axis direction.

Structures of the hook 333 and the auxiliary member 335, relative arrangement structures of the hook 333 and the auxiliary member 335, and a structure in which the damper member 350a is provided in the hook 333 and the auxiliary member 335 are the same as those described above with reference to FIGS. 3 to 6, and thus a detailed description thereof will be omitted.

Through the above-described example embodiments, the camera module, according to an example embodiment of the present disclosure, may secure sufficient strength against external impacts while having a reduced size.

While this disclosure includes specific examples, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module comprising:
a carrier disposed in a housing;
a guide member disposed in the carrier, and configured to compensate for shaking in a perpendicular direction to an optical axis direction;
a stopper configured to cover an upper portion of the carrier to accommodate the guide member; and
a damper member, disposed in the stopper, comprising either one or both of an eleventh damper member opposing the guide member in a first direction perpendicular to the optical axis direction, and a twenty first damper member opposing the guide member in a second direction perpendicular to the optical axis direction and the first direction,
wherein the damper member directly opposes the guide member.

2. The camera module of claim 1, wherein the damper member further includes either one or both of a twelfth damper member opposing the housing in the first direction, and a twenty-second damper member opposing the housing in the optical axis direction and the second direction.

3. The camera module of claim 2, wherein the damper member is a single member.

4. The camera module of claim 2,
wherein the stopper includes an auxiliary member extending from a frame in the optical axis direction, and a plurality of hooks extending from a body in the optical axis direction, and
wherein the damper member is fixed to or disposed on one of the hooks and the auxiliary member.

5. The camera module of claim 2,
wherein the stopper includes an auxiliary member extending from a frame in the optical axis direction, and a plurality of hooks extending from a body in the optical axis direction, and
wherein each of the hooks has a through-hole and is configured to fix to the carrier, and the damper member is disposed on opposing sides of the through-hole.

6. The camera module of claim 1, wherein
the stopper includes:
a body having a shape of a frame; and
a plurality of hooks extending from the body in the optical axis direction,
wherein the damper member is disposed on each of the hooks.

7. The camera module of claim 6, wherein the body has a rectangular shape.

8. The camera module of claim 6, wherein
the stopper includes an auxiliary member extending from the frame in the optical axis direction, and
the damper member is fixed to or disposed on one of the hooks and the auxiliary member.

9. The camera module of claim 6, wherein
each of the hooks has a through-hole and is configured to fix to the carrier, and
the damper member protrudes from opposing sides of the through-hole.

10. The camera module of claim 6, wherein the damper member has a fitting groove configured to fit one of the hooks.

11. The camera module of claim 6, wherein the damper member has a first fitting groove or a second fitting groove configured to fit one of the hooks or the auxiliary member.

12. The camera module of claim 1, wherein the guide member includes a frame and a lens holder, disposed in the carrier in the optical axis direction, moving together with the carrier in the optical axis direction, and movable in the first direction and the second direction, respectively.

13. The camera module of claim 1, wherein the guide member is configured as a single member, and to be driven in both the first direction and the second direction.

14. The camera module of claim 1, wherein the stopper includes, separately from the damper member, a damping member including either one or both of a first damping member opposing a case of the camera module in the optical axis direction, and a second damping member opposing the guide member in the optical axis direction.

15. The camera module of claim 1, wherein the damper member is a single member.

16. A stopper comprising:
a body having a rectangular frame;
a hook configured to extend from the rectangular frame in a downward direction toward one surface of the frame; and
a damper member, disposed on the hook, comprising either one or both of an eleventh directional damper member opposing inwardly in the downward direction and in a first direction perpendicular to the downward direction, or a twenty first directional damper member opposing inwardly in the downward direction and in a second direction perpendicular to the downward direction and the first direction.

17. The stopper of claim 16, wherein the damper member further includes either one or both of an eleventh directional damper member opposing outwardly in the first direction perpendicular to the downward direction, and a twenty first directional damper member opposing outwardly in the second direction perpendicular to the downward direction and the first direction.

18. The stopper of claim 16, wherein the hook is disposed at a corner portion of the body having a rectangular shape.
